(19) United States
(12) Patent Application Publication
(10) Pub. No.: US 2026/0329792 A1
(43) Pub. Date: Oct. 22, 2026

(54) VEHICLE DATA PROCESSING METHOD, APPARATUS, AND VEHICLE AND STORAGE MEDIUM

(71) Applicant: Chongqing Changan Technology Co., Ltd., Chongqing (CN)

(72) Inventors: Xinyu GU, Chongqing (CN); Ling WANG, Chongqing (CN); Xiaowei WANG, Chongqing (CN)

(73) Assignee: Chongqing Changan Technology Co., Ltd., Chongqing (CN)

(21) Appl. No.: 19/705,809

(22) Filed: Jun. 12, 2026

Related U.S. Application Data
(63) Continuation of application No. PCT/CN2025/104962, filed on Jun. 27, 2025.

(30) Foreign Application Priority Data
Jan. 9, 2025 (CN) 202510036334.2

(51) Int. Cl. G06F 13/38

(52) U.S. Cl. CPC G06F 13/38; G06F 2213/40

(57) ABSTRACT

A vehicle data processing method and apparatus, a vehicle and a storage medium, including performing data acquisition on basic software of a vehicle control operating system of a vehicle-mounted intelligent driving host via a communication software gateway, a bridging channel and a mirroring channel to generate a parsable file; determining a forwarding routing table according to the parsable file; parsing the parsable file to generate a network message; and back-injecting the network message into the basic software of the vehicle control operating system based on the forwarding routing table. By performing data acquisition on the operation of the basic software of the vehicle control operating system on the vehicle-mounted intelligent driving host, operation monitoring is realized and parsable files are generated, facilitating data back-injection.

### CROSS-REFERENCE TO RELATED APPLICATIONS

The present application is a continuation of International Application No. PCT/CN2025/104962, filed on Jun. 27, 2025, which claims the priority to Chinese Patent Application No. 2025100363342, filed with the China National Intellectual Property Administration on Jan. 9, 2025 and entitled “VEHICLE DATA PROCESSING METHOD, APPARATUS, AND VEHICLE AND STORAGE MEDIUM”. The disclosures of the aforementioned applications are hereby incorporated by reference in their entireties.

### TECHNICAL FIELD

The present application relates to the technical field of vehicle intelligent driving, and in particular to a vehicle data processing method, a vehicle data processing apparatus, a vehicle and a computer-readable storage medium.

### BACKGROUND

With the popularization of intelligent driving and assisted driving, the stable operation of driving control systems is paramount to ensuring driving safety. However, related art mainly focuses on performance monitoring and debugging of the operating system itself, while paying little attention to monitoring and debugging methods for vehicle control operating system software in intelligent driving scenarios. There is a lack of technical solutions for data acquisition, back-injection and debugging of the vehicle control operating system software.

### SUMMARY

A first objective of the present application is to provide a vehicle data processing method, so as to solve the problem in the prior art of monitoring and performing data back-injection on basic software of a vehicle control operating system. A second objective is to provide a vehicle data processing apparatus; a third objective is to provide a vehicle; and a fourth objective is to provide a computer-readable storage medium.

To realize the above objectives, the technical solutions adopted by the present application are as follows.

The present application provides a vehicle data processing method, which is applied to a vehicle-mounted debugging industrial personal computer, where the vehicle-mounted debugging industrial personal computer is connected to a vehicle-mounted intelligent driving host via a communication software gateway, a bridging channel and a mirroring channel, and the method includes:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

Further, the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; where the step of performing the data acquisition on the basic software of the vehicle control operating system of the vehicle-mounted intelligent driving host via the communication software gateway, the bridging channel and the mirroring channel to generate the parsable file includes:
acquiring and packaging data of the system-on-chip via the communication software gateway to generate a text format file;
acquiring and packaging data of the sensor via the bridging channel to generate a first packet capture format file;
acquiring and packaging data of the micro electronic control unit via the mirroring channel to generate a second packet capture format file; and
combining the text format file, the first packet capture format file and the second packet capture format file to generate the parsable file.

Further, the step of determining the forwarding routing table according to the parsable file includes:
reading the parsable file, and determining a data processing process node corresponding to the parsable file; and
determining the forwarding routing table based on the data processing process node.

Further, the step of back-injecting the network message into the basic software of the vehicle control operating system includes:
back-injecting the network message from the data processing process node to an operating node of the basic software of the vehicle control operating system.

Further, the data processing process node includes an output processing node, the step of back-injecting the network message from the data processing process node to the operating node of the basic software of the vehicle control operating system includes:
back-injecting the network message from the output processing node to the operating node of the basic software of the vehicle control operating system.

Further, the data processing process node further includes a process processing node, the step of back-injecting the network message from the data processing process node to the operating node of the basic software of the vehicle control operating system further includes:
back-injecting the network message sequentially into the process processing node, the output processing node, and the operating node of the basic software of the vehicle control operating system.

Further, the data processing process node further includes an input processing node, the step of back-injecting the network message from the data processing process node to the operating node of the basic software of the vehicle control operating system further includes: back-injecting the network message sequentially into the input processing node, the process processing node, the output processing node, and the operating node of the basic software of the vehicle control operating system.

Further, a first debugging tool is pre-set in the system-on-chip; after the step of back-injecting the network message into the basic software of the vehicle control operating system based on the forwarding routing table, the method further includes:
sending a first debugging data capture command to the system-on-chip, where the system-on-chip is configured to activate the first debugging tool in response to the first debugging data capture command;
receiving task scheduling monitoring data acquired by the first debugging tool; and
generating a flame graph file according to the task scheduling monitoring data.

Further, a second debugging tool is pre-set in the micro electronic control unit, and the method further includes:
sending a second debugging data capture command to the micro electronic control unit, where the micro electronic control unit is configured to activate the second debugging tool in response to the second debugging data capture command;
receiving target operating duration data acquired by the second debugging tool; and
combining the task scheduling monitoring data and the target operating duration data to generate joint scheduling curve data.

The present application provides a vehicle data processing apparatus, which is applied to a vehicle-mounted debugging industrial personal computer, where the vehicle-mounted debugging industrial personal computer is connected to a vehicle-mounted intelligent driving host via a communication software gateway, a bridging channel and a mirroring channel, and the apparatus includes:
an acquisition module, configured to perform data acquisition on basic software of a vehicle control operating system of the vehicle-mounted intelligent driving host via the communication software gateway, the bridging channel and the mirroring channel to generate a parsable file;
a routing determination module, configured to determine a forwarding routing table according to the parsable file;
a parsing module, configured to parse the parsable file to generate a network message; and
a back-injection module, configured to back-inject the network message into the basic software of the vehicle control operating system based on the forwarding routing table.

The present application provides a vehicle, which includes: a processor, a memory, and a computer program stored in the memory and executable on the processor; where the computer program, when executed by the processor, implements the step of the vehicle data processing method as described above.

The present application provides a computer-readable storage medium, where a computer program is stored on the computer-readable storage medium, and the computer program, when executed by a processor, implements the step of the vehicle data processing method as described above.

Beneficial effects of the present application are as follows:
(1) Data acquisition is performed on the operation of the basic software of the vehicle control operating system of the vehicle-mounted intelligent driving host via the communication software gateway, the bridging channel and the mirroring channel, so as to realize operation monitoring of the basic software of the vehicle control operating system and facilitate the analysis of software faults and potential risks.
(2) The acquired data, by a basic software of the vehicle control operating system, is generated into a parsable file, which can be directly parsed and forwarded in the subsequent process, thereby facilitating data back-injection and improving the efficiency of back-injection.

Based on the forwarding routing table, the data is back-injected into the basic software of the vehicle control operating system, thereby realizing data back-injection for the basic software of the vehicle control operating system. Comprehensive offline debugging can be performed on the basic software of the vehicle control operating system, which improves the comprehensiveness and accuracy of debugging.

### BRIEF DESCRIPTION OF DRAWINGS

FIG. 1 is a step flowchart according to an embodiment of a vehicle data processing method of the present application.

FIG. 2 is a schematic diagram of a hardware architecture of a vehicle-mounted intelligent driving host according to an embodiment of a vehicle data processing method of the present application.

FIG. 3 is a step flowchart according to another embodiment of a vehicle data processing method of the present application.

FIG. 4 is a schematic diagram of a hardware connection relationship according to another embodiment of a vehicle data processing method of the present application.

FIG. 5 is a functional block diagram of a vehicle-mounted debugging industrial personal computer.

FIG. 6 is a data acquisition block diagram of basic software of a vehicle-mounted host operating system.

FIG. 7 is a schematic framework diagram of a monitoring & debugging central node for basic software of a vehicle-mounted host operating system.

FIG. 8 is a schematic diagram of data back-injection.

FIG. 9 is a schematic framework diagram of cross-chip joint debugging.

FIG. 10 is a structural block diagram according to an embodiment of a vehicle data processing apparatus of the present application.

FIG. 11 is a schematic diagram of a processor and a storage medium according to an embodiment of a vehicle of the present application.

FIG. 12 is a schematic diagram of an embodiment of a computer-readable storage medium of the present application.

### DESCRIPTION OF EMBODIMENTS

Implementations of the present application will be described below with reference to the accompanying drawings and examples. Those skilled in the art can readily appreciate other advantages and effects of the present application from the disclosure of the present specification. The present application may also be implemented or applied through other different specific embodiments, and various modifications and changes may be made to the details in this specification based on different perspectives and applications without departing from the spirit of the present application. It should be understood that the embodiments are merely illustrative of the present application and are not intended to limit the scope of protection thereof.

It should be noted that the drawings provided in the following embodiments only schematically illustrate the basic concept of the present application. The drawings only show components related to the present application, rather than being drawn according to the actual number, shape and size of components in actual implementation. In practical implementation, the form, quantity and proportion of each component may be arbitrarily changed, and the layout form of the components may also be more complex.

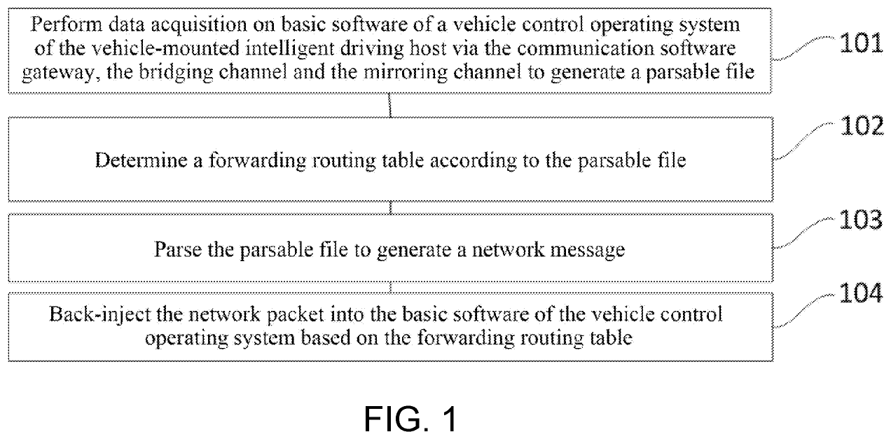

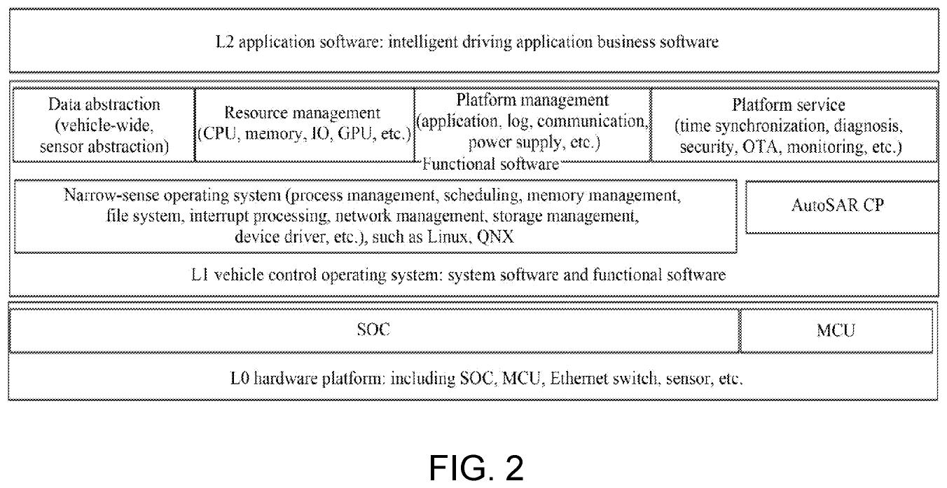

Referring to FIG. 1, there is shown a step flowchart according to an embodiment of a vehicle data processing method of the present application. The vehicle data processing method is applied to a vehicle-mounted debugging industrial personal computer, which is connected to a vehicle-mounted intelligent driving host via a communication software gateway, a bridging channel and a mirroring channel. The vehicle-mounted debugging industrial personal computer is dedicated computer equipment installed inside a vehicle, which is configured to debug, monitor and control the working status of various systems and components of the vehicle. The communication software gateway is a software program executed on a vehicle control operating system to realize gateway functions. The bridging channel is a communication channel established between the vehicle-mounted debugging industrial personal computer and the vehicle-mounted intelligent driving host by means of bridging technology. The mirroring channel is a communication channel between the vehicle-mounted debugging industrial personal computer and the vehicle-mounted intelligent driving host for packet replication and monitoring. The vehicle-mounted debugging industrial personal computer is connected to the vehicle-mounted intelligent driving host via the communication software gateway, the bridging channel and the mirroring channel. As shown in FIG. 2, an architecture of the vehicle-mounted intelligent driving host is mainly divided into a hardware platform (defined as Layer L0), an intelligent driving vehicle control operating system (defined as Layer L1, also referred to as a generalized operating system), and intelligent driving application software (defined as Layer L2). The Layer L1 intelligent driving vehicle control operating system software mainly includes system software (also referred to as a narrow-sense operating system) and functional software, which runs on multiple chips. The involved data mainly includes: (1) input data: vehicle-wide data, sensor data and the like; (2) output data: data processed by the Layer L1 software and output to the Layer L2 software; (3) process data: data generated during the operating state and processing procedure of the Layer L1 software, such as operating system status data, fault diagnosis data, cross-chip interaction data and so on. The basic software of the vehicle control operating system of the vehicle-mounted intelligent driving host corresponds to the Layer L1 software.

The vehicle data processing method may specifically include the following steps:
Step 101: perform data acquisition on the basic software of the vehicle control operating system of the vehicle-mounted intelligent driving host via the communication software gateway, the bridging channel and the mirroring channel to generate a parsable file.

For different contents (such as vehicle sensor data, basic software application data, operating system data, hardware status data, diagnostic faults, functional safety faults, logs and other information) in the basic software of the vehicle control operating system of the vehicle-mounted intelligent driving host, data acquisition may be performed via the communication software gateway, the bridging channel and the mirroring channel by adopting corresponding plugins. The acquired data may be packaged into a unified format to generate a parsable file. The parsable file is a file in a format recognizable and parsable by a network device or a computer device. The parsable file may be in formats such as pcap (network packet capture file format) or dat (data) format and so on.
Step 102: determine a forwarding routing table according to the parsable file.

Then, a corresponding forwarding routing table for routing via the gateway is determined based on the content in the parsable file.
Step 103: parse the parsable file to generate a network message.

In addition, the parsable file may be parsed to generate the network message, where the network message is a communication network message, such as an Ethernet network packet.
Step 104: back-inject the network message into the basic software of the vehicle control operating system based on the forwarding routing table.

Subsequently, based on the forwarding routing table, the network message is subjected to step-by-step data back-injection to be injected back to the basic software of the vehicle control operating system for corresponding debugging.

In the embodiment of the present application, the data acquisition is performed on the basic software of the vehicle control operating system of the vehicle-mounted intelligent driving host via the communication software gateway, the bridging channel and the mirroring channel to generate the parsable file; the forwarding routing table is determined according to the parsable file; the parsable file is parsed to generate the network message; and the network message is back-injected into the basic software of the vehicle control operating system based on the forwarding routing table. The data acquisition is performed on the operation of the basic software of the vehicle control operating system of the vehicle-mounted intelligent driving host via the communication software gateway, the bridging channel and the mirroring channel, so as to realize operation monitoring of the basic software of the vehicle control operating system and facilitate the analysis of software faults and potential risks. The acquired data, by a basic software of the vehicle control operating system, is generated into a parsable file, which can be directly parsed and forwarded in the subsequent process, thereby facilitating data back-injection and improving the efficiency of back-injection. Based on the forwarding routing table, the data is back-injected into the basic software of the vehicle control operating system, thereby realizing data back-injection for the basic software of the vehicle control operating system. Comprehensive offline debugging can be performed on the basic software of the vehicle control operating system, which improves the comprehensiveness and accuracy of debugging.

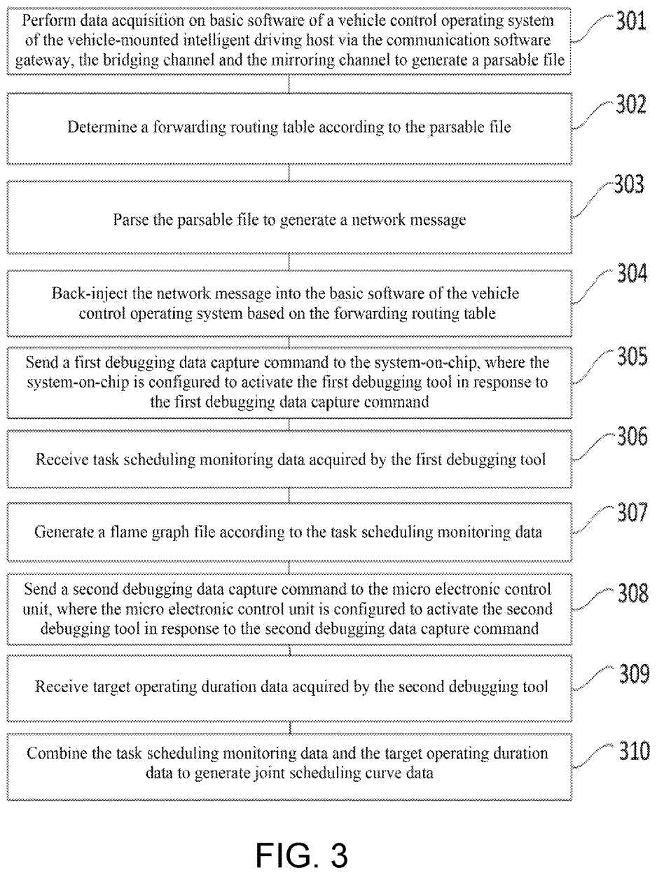

Referring to FIG. 3, there is shown a step flowchart according to another embodiment of the vehicle data processing method of the present application. The vehicle data processing method is applied to a vehicle-mounted debugging industrial personal computer, which is connected to a vehicle-mounted intelligent driving host via a communication software gateway, a bridging channel and a mirroring channel. Specifically, the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel. The basic software of the vehicle control operating system is deployed on the system-on-chip, the sensor and the micro electronic control unit.

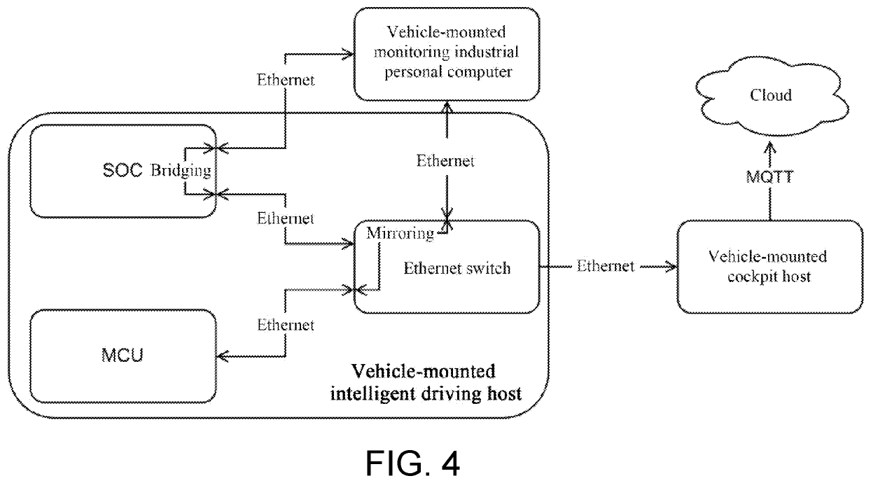

Reference may be made to FIG. 4. The vehicle-mounted intelligent driving host mainly includes an SOC (system on chip) chip and an MCU (microcontroller unit) chip, which support the operation of intelligent driving software and perform connection and communication via an Ethernet switch. (1) The SOC bridges a network port connected to the Ethernet switch and a network port connected to the vehicle-mounted monitoring industrial personal computer, so that the vehicle-mounted monitoring industrial personal computer can directly acquire data interacted between the SOC and the Ethernet switch. (2) The Ethernet switch mirrors the interface connected to the MCU and connects it to the vehicle-mounted monitoring industrial personal computer, so that the vehicle-mounted monitoring industrial personal computer can directly acquire data interacted between the MCU and the Ethernet switch. (3) The vehicle-mounted intelligent driving host interacts with a vehicle-mounted cockpit host through the Ethernet switch, and the vehicle-mounted cockpit host can transmit data to cloud via MQTT (message queuing telemetry transport).

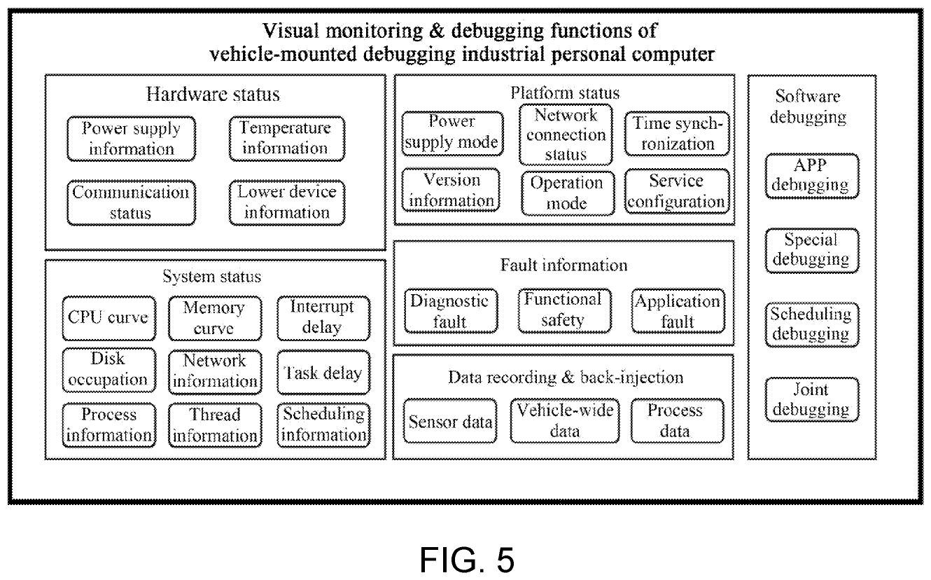

The functions of the vehicle-mounted debugging industrial personal computer can be described as shown in FIG. 5: (1) Monitoring function, hardware status monitoring: capable of displaying hardware information such as power supply, temperature, communication status, connection status of lower devices and so on. System status monitoring: capable of displaying system status information such as multi-core CPU (central processing unit) utilization curve, memory consumption curve, interrupt list and delay, disk occupation statistics, process information, thread information and so on. Platform status monitoring: capable of displaying platform information such as power supply mode, network connection status, software version information, time synchronization status, operation mode, service DID (direct inward dialing) configuration, and so on. Fault information monitoring: capable of displaying information such as faults acquired by the diagnosis system, faults acquired by functional safety, faults generated by applications themselves and so on. Data recording and back-injection function: capable of displaying input data such as original sensor data and vehicle-wide data, process data interacted among various APPs during processing by the basic software platform, processed output data and so on. The data can be recorded into files in dat and pcap formats for back-injection during offline software debugging. (2) Debugging function: mainly including DEBUG (bug) debugging of APP (application program), special debugging such as troubleshooting memory leakage and high CPU occupation rate, system scheduling task arrangement and monitoring debugging, multi-chip function debugging across SOC and MCU and so on.

The vehicle data processing method may specifically include the following steps.
Step 301, perform data acquisition on basic software of the vehicle control operating system of the vehicle-mounted intelligent driving host via the communication software gateway, the bridging channel and the mirroring channel to generate a parsable file.

Different contents in the basic software of the vehicle control operating system of the vehicle-mounted intelligent driving host may be acquired via the communication software gateway, the bridging channel and the mirroring channel by means of input plugins for data acquisition. The acquired data is uniformly packaged by the framework into parsable files in pcap or dat format.

Further, the step of performing the data acquisition on the basic software of the vehicle control operating system of the vehicle-mounted intelligent driving host via the communication software gateway, the bridging channel and the mirroring channel to generate the parsable file may include: acquiring and packaging data of the system-on-chip via the communication software gateway to generate a text format file; acquiring and packaging data of the sensor via the bridging channel to generate a first packet capture format file; acquiring and packaging data of the micro electronic control unit via the mirroring channel to generate a second packet capture format file; and combining the text format file, the first packet capture format file and the second packet capture format file to generate the parsable file.

Data of the system-on-chip may be acquired and packaged via the communication software gateway to generate the text format file, and the text format file may be a DAT format file. Data of the sensor is acquired and packaged via the bridging channel to generate the first packet capture format file. The first packet capture format file is a packet capture format file generated by acquiring and packaging sensor data, and may be a pcap file. Correspondingly, data of the micro electronic control unit is acquired and packaged via the mirroring channel to generate the second packet capture format file. The second packet capture format file is a packet capture format file generated by acquiring and packaging data of the micro electronic control unit, and may also be a pcap file. Finally, the text format file, the first packet capture format file and the second packet capture format file are combined to jointly serve as the parsable file.

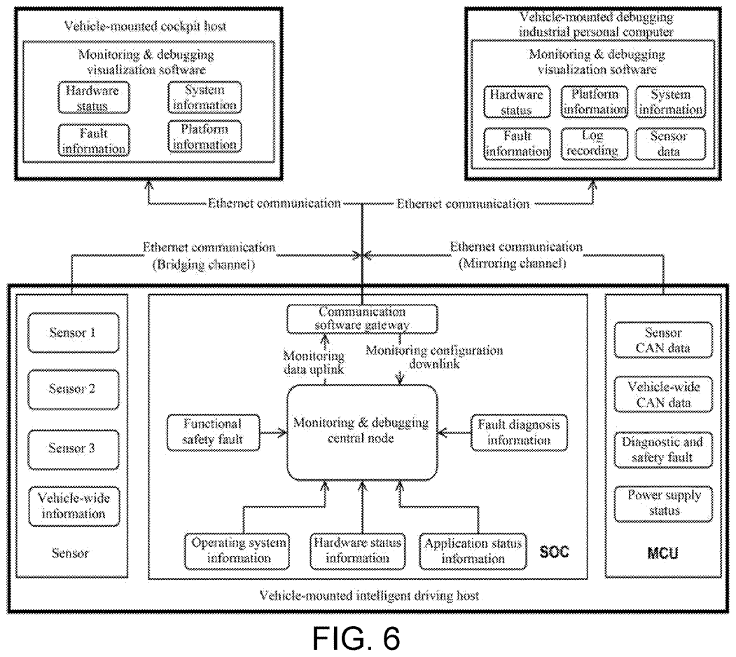

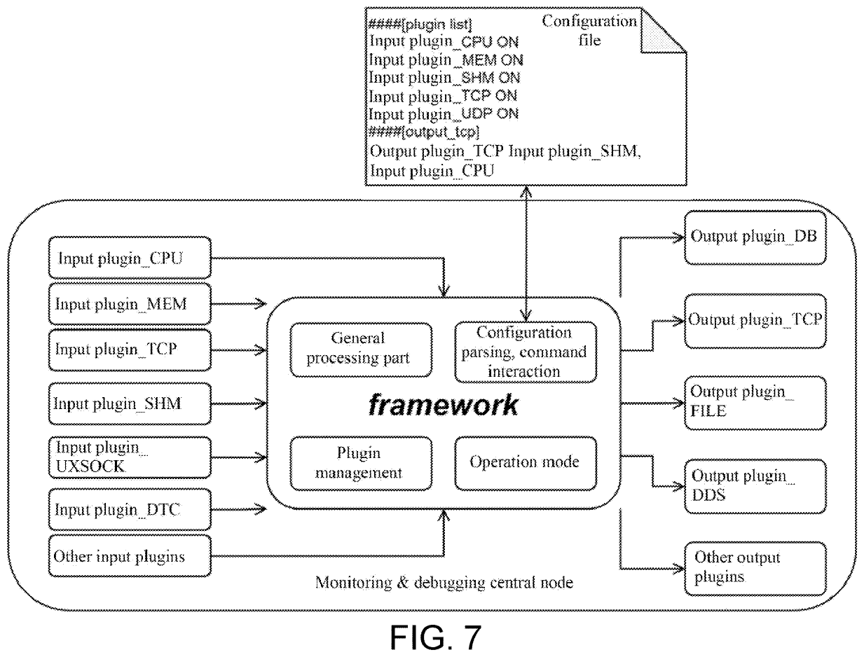

For example, reference may be made to FIG. 6. On the SOC side, operating system information, hardware status, application status, diagnostic faults, functional safety faults, and so on that need to be monitored are collected through a monitoring & debugging central node, and packaged into a unified format, and transmitted to the visual monitoring & debugging software via the communication software gateway. Process data and output data generated by various APPs are saved as a file in the format of “Output/Process Data xx_Year%_Month%_Day%_Hour%_Minute%_Second%.dat” to facilitate offline back-injection. (2) Sensor information is directly transmitted to the visual monitoring & debugging software via the bridging channel. (3) Monitoring information on the MCU side is directly transmitted to the visual monitoring & debugging software via the mirroring channel. The sensor data and vehicle-wide data collected in (2) and (3) are saved as a file in the format of “Sensor xx_Year%_Month%_Day%_Hour%_Minute%_Second%.pcap” to facilitate offline back-injection. The monitoring information acquired by the vehicle-mounted cockpit host is a subset of the monitoring information acquired by the vehicle-mounted debugging industrial personal computer. The visual monitoring & debugging software issues monitoring configurations via the communication channel, and the monitoring & debugging central node selects and configures modules to be monitored. Reference may be made to FIG. 7 for the framework of the monitoring & debugging central node for the basic software of the vehicle-mounted host operating system, which is mainly composed of four parts: input plugins, the central node adopts a plugin-based design and accesses data through input plugins, for example it may access data via shared memory by means of the input plugin_SHM, access data via TCP communication by means of the input plugin _TCP, directly invoke a system interface to acquire CPU information by means of the input plugin_CPU, and directly subscribe to fault DTCs issued by the diagnostic module by means of the input plugin_DTC. The input plugins support dynamic configuration and expansion according to standard templates. Debug commands issued by the visual monitoring & debugging software can be input via the TCP module, processed, and then output to corresponding debugging tools to control the debugging tools to execute debugging actions. For configuration file, it can be statically configured during initialization or dynamically modified by the visual monitoring & debugging software. The configuration file mainly includes an input plugin list and output plugin configuration, an output plugin is followed by an input plugin, indicating the routing relationship from input to output. General processing part of the framework: it is responsible for implementing general processing functions such as plugin data routing, unified format packaging and so on. Configuration parsing and command interaction: it is responsible for command line interaction and configuration file parsing. Plugin Management: it uniformly manages registration, operation, exit and so on. Operation mode: it is responsible for implementing and switching system operation modes, the operation modes including debugging mode, periodic mode, and real-time mode. Output Plugins: the central node adopts a plugin design for external data output. For example: the output plugin_DB may output formatted data to a database DB; the output plugin_TCP and output plugin_DDS may output formatted data to the visualization software on the vehicle-mounted cockpit host and the vehicle-mounted monitoring and debugging industrial personal computer; the output plugin_FILE may output formatted data to a file for storage. The output plugins may be configured statically or dynamically according to the configuration file, and may be extended according to a definition in the standard template form defined by the framework. Vehicle sensor data, basic software application data, operating system data, hardware status data, diagnostic faults, functional safety faults, logs and other information are acquired respectively through input plugins for CPU, MEM, TCP, SHM, UXSOCK, DTC, etc., of the monitoring & debugging central node, uniformly packaged into data files in pcap or dat format by the framework, and sent to the vehicle-mounted monitoring industrial personal computer or vehicle cockpit host via the communication gateway by means of output plugins for TCP, DDS, etc., for display, storage and replay by the monitoring & debugging visualization software. The monitoring & debugging central node is designed with input plugins (for CPU, MEM, TCP, SHM, etc.) and output plugins (for TCP, DDS, FILE, etc.), acquires one type of data by one type of input plugin. One or several output plugins are defined by the configuration file, corresponding to one or several types of communication for transmitting data out of the board or saving data on the board for data output.
Step 302: determine a forwarding routing table according to the parsable file.

The forwarding routing table may be determined according to the data type in the parsable file.

Specifically, the step of determining a forwarding routing table according to the parsable file includes: reading the parsable file, determining a data processing process node corresponding to the parsable file; and determining the forwarding routing table based on the data processing process node.

First, the parsable file may be read to determine the data processing process node corresponding to the data contained in the parsable file. The data processing process node refers to the service process stage when the data is generated, such as a node in a data input stage, a node in a data calculation stage, and a node in a data output stage. The target routing position is determined according to the data processing process node, so as to determine the forwarding routing table.
Step 303: parse the parsable file to generate a network message.

The parsable file is parsed and converted into the network packet according to the communication requirements of the corresponding communication network. For example, the acquired and saved parsable files such as “Sensor xx_Year%_Month%_Day%_Hour%_Minute%_Second%.pcap” and “Output/ProcessData xx_Year%_Month%_Day%_Hour%_Minute%_Second%.dat” are parsed into Ethernet packets.
Step 304: back-inject the network message into the basic software of the vehicle control operating system based on the forwarding routing table.

For the routing configuration table in the communication software gateway, the routing configuration table is configured with topics and corresponding forwarding path in the format of “topic: certain data->certain APP”, respectively sending to an internal APP of the L1-layer operating system software according to the forwarding path, allows the APP to run and process the data again to verify whether the operation of the APP conforms to design expectations, thereby implementing data back-injection and achieving the purpose of comprehensive offline debugging of L1-layer software.

In an embodiment of the present application, the step of back-injecting the network message into the basic software of the vehicle control operating system includes: back-injecting the network message from the data processing process node to an operating node of the basic software of the vehicle control operating system.

In accordance with different data processing process nodes, network messages may be back-injected from the data processing process nodes until being back-injected to the operating nodes of the basic software of the vehicle control operating system, so as to realize the purpose of comprehensive debugging.

Specifically, the data processing process node includes an output processing node, the step of back-injecting the network message from the data processing process node to the operating node of the basic software of the vehicle control operating system includes: back-injecting the network message from the output processing node to the operating node of the basic software of the vehicle control operating system.

The output processing node indicates that the data is in the output processing stage. Therefore, when the data has already in the current stage, it is only necessary to back-inject the network messages from the output processing node to the operating node of the basic software of the vehicle control operating system, so as to realize the purpose of comprehensive debugging.

Specifically, the data processing process node further includes a process processing node, the step of back-injecting the network message from the data processing process node to the operating node of the basic software of the vehicle control operating system further includes: back-injecting the network message sequentially into the process processing node, the output processing node, and the operating node of the basic software of the vehicle control operating system.

The process processing node indicates that the data is in the data operation stage and still requires output processing in the subsequent stage. The network messages may be back-injected sequentially to the process processing node, the output processing node, and the operating node of the basic software of the vehicle control operating system, so as to realize the purpose of comprehensive debugging.

Specifically, the data processing process node further includes an input processing node, the step of back-injecting the network message from the data processing process node to the operating node of the basic software of the vehicle control operating system further includes: back-injecting the network message sequentially into the input processing node, the process processing node, the output processing node, and the operating node of the basic software of the vehicle control operating system.

The input processing node indicates that the data is in the data input stage, and still requires data operation and output processing in subsequent stages. The network messages may be back-injected sequentially to the input processing node, the process processing node, the output processing node, and the operating node of the basic software of the vehicle control operating system, so as to realize the purpose of comprehensive debugging.

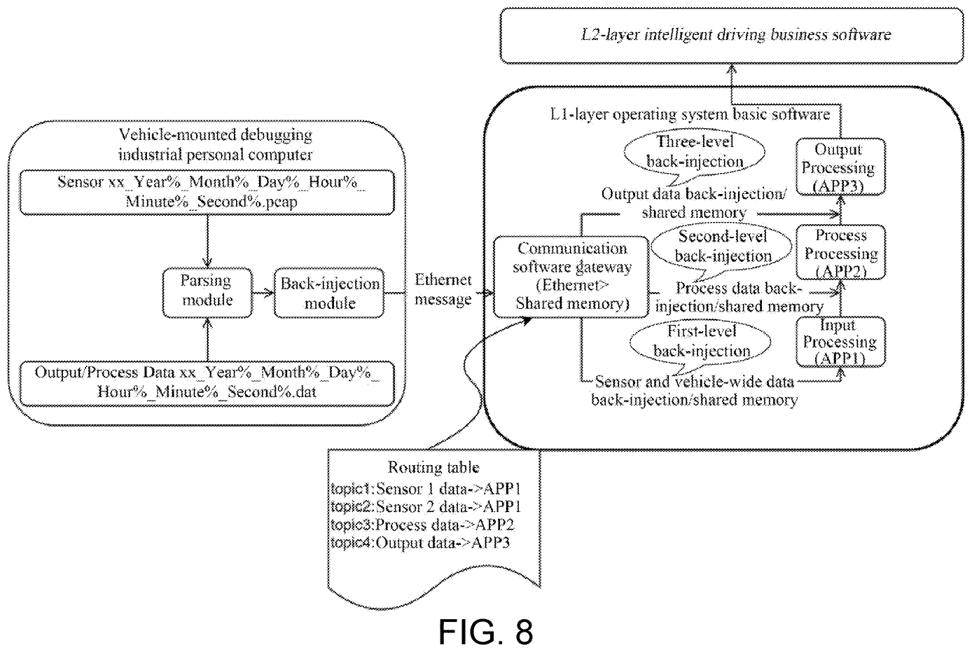

For example, for data back-injection, reference may be made to FIG. 8. The acquired and saved files in the monitoring function, namely “Sensor xx_Year%_Month%_Day%_Hour%_Minute%_Second%.pcap” and “Output/Process Data xx_Year%_Month%_Day%_Hour%_Minute%_Second%.dat” are parsed into the Ethernet messages by the parsing module, which are then back-injected into the communication software gateway in the vehicle-mounted intelligent driving host via the back-injection module. Meanwhile, a back-injection data forwarding routing table is generated. The communication software gateway back-injects external Ethernet message data into respective APPs of the basic software of the operating system respectively through shared memory according to paths specified in the routing table. The data processing process in the basic software is defined as: Input Processing (APP1)->Process Processing (APP2)->Output Processing (APP3). Three back-injection modes are defined as follows:
(1) Three-level back-injection: the original sensor data and vehicle-wide data in the pcap file are parsed and then routed to APP1 according to the routing table, e.g., “topic1: Sensor 1 data->APP1”, to debug the entire software processing process of APP1->APP2->APP3->intelligent driving service software.
(2) Two-level back-injection: the process data in the dat file is parsed and then routed to APP2 according to the routing table, e.g., “topic3: Process data->APP2”, to debug the software processing process of APP2->APP3->intelligent driving service software.
(3) One-level back-injection: the output data in the dat file is parsed and then routed to APP 3 according to the routing table, e.g., “topic4: Output data->APP3”, to debug the software processing process of APP3->intelligent driving service software.

Step 305, send a first debugging data capture command to the system-on-chip, where the system-on-chip is configured to activate a first debugging tool in response to the first debugging data capture command.

In addition, during vehicle production, debugging tools are pre-installed on the vehicle-mounted intelligent driving host. The debugging tools are set to an inactive state by default. When a fault occurs in the vehicle control operating system, and issue localization or specialized debugging is needed, a corresponding debugging tool is activated for processing.

A first debugging tool is pre-set on the system-on-chip. The first debugging tool refers to a debugging tool pre-set on the SoC.

A first debugging data capture command can be sent to the SoC, i.e., a corresponding command to activate the first debugging tool for the first debugging data capture command. Upon receiving the first debugging data capture command, the SoC activates the first debugging tool in response to the first debugging data capture command. The first debugging tool captures various data for debugging after data back-injection. Such data may include task scheduling monitoring data that records task scheduling status.
Step 306, receive task scheduling monitoring data acquired by the first debugging tool.

The task scheduling monitoring data acquired by the first debugging tool may be received.
Step 307, generate a flame graph file according to the task scheduling monitoring data.

Then, the task scheduling monitoring data is summarized based on tools such as perf and trace, to generate a visualized flame graph file for relevant personnel to clearly understand the debugging status.
Step 308, send a second debugging data capture command to the micro electronic control unit, where the micro electronic control unit is configured to activate a second debugging tool in response to the second debugging data capture command.

Correspondingly, a second debugging tool is pre-set on the micro electronic control unit. The second debugging tool is a debugging tool pre-set on the micro electronic control unit.

A second debugging data capture command can be sent to the micro electronic control unit, i.e., a corresponding command to activate the second debugging tool for the second debugging data capture command. Upon receiving the second debugging data capture command, the micro electronic control unit activates the second debugging tool in response to the second debugging data capture command. The second debugging tool captures various data for debugging after data back-injection. Such data may include target operating duration data of each task, which is to detect the operating duration of a specific task.
Step 309, receive target operating duration data acquired by the second debugging tool.

Target operating duration data acquired by the second debugging tool may be received for summarization.
Step 310, combine the task scheduling monitoring data and the target operating duration data to generate joint scheduling curve data.

For each task, the task scheduling monitoring data and target operating duration data of the corresponding task are combined to generate joint scheduling curve data of multiple tasks during the debugging process.

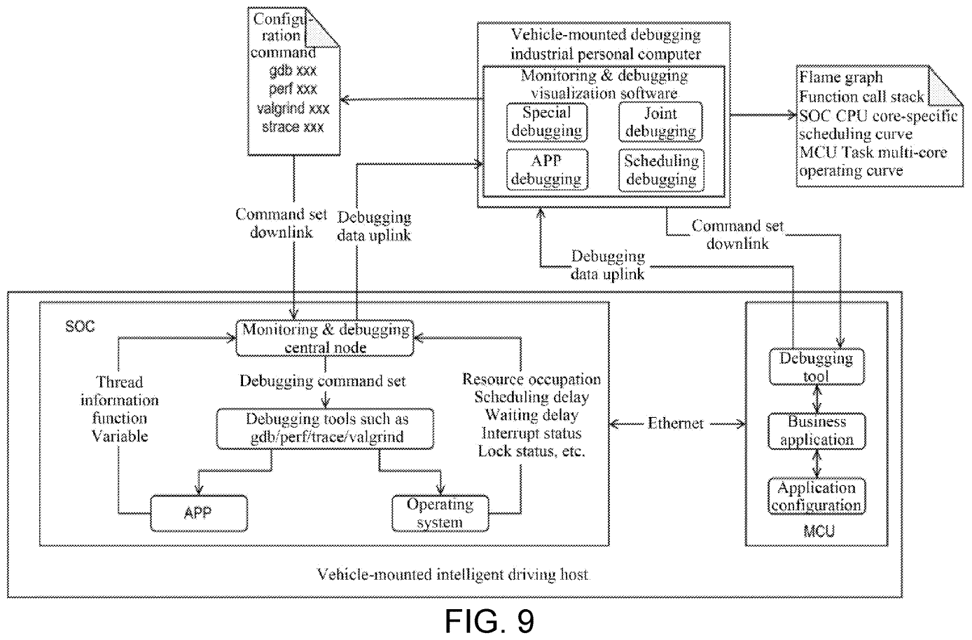

For example, reference may be made to FIG. 9. Command sets may be configured for items including APP debugging, special debugging, scheduling debugging and joint debugging. A corresponding debugging mode may be selected. The command set is sent to the SoC and MCU respectively via Ethernet to activate the default pre-set debugging tools on the SoC and MCU. Designated applications can be debugged via GDB; data can be captured to generate flame graphs by means of pre-set tools such as perf and trace; memory issues can be analyzed through visualized operation of tools like valgrind. The scheduling status of task scheduling of the multi-core operating system on the SoC side can be acquired by controlling tools such as strace. The task running duration can be acquired via a tool on the MCU to generate joint scheduling curves on the monitoring industrial personal computer, as so to realize dynamic joint debugging of cross-chip functions between the SoC and MCU.

The embodiments of the present application bring many conveniences by ensuring stable operation and simulation debugging of the basic software of the operating system of the vehicle-mounted intelligent driving host. Comprehensive offline debugging is realized for various module processing links within the offline debugging vehicle control operating system, which has great significance. From the overall perspective of the basic software layer of the operating system, it is of great significance to debug cross-chip overall functionality and develop reliable and efficient software.

It should be noted that for convenience of concise description, the method embodiments are expressed as a series of action combinations. Those skilled in the art shall understand that the embodiments of the present application are not limited by the order of the described actions, because according to the embodiments of the present application, certain steps may be performed in other orders or simultaneously. In addition, those skilled in the art shall understand that the embodiments recorded in the specification are all embodiments, and the involved actions are not necessarily essential steps for implementing the present application.

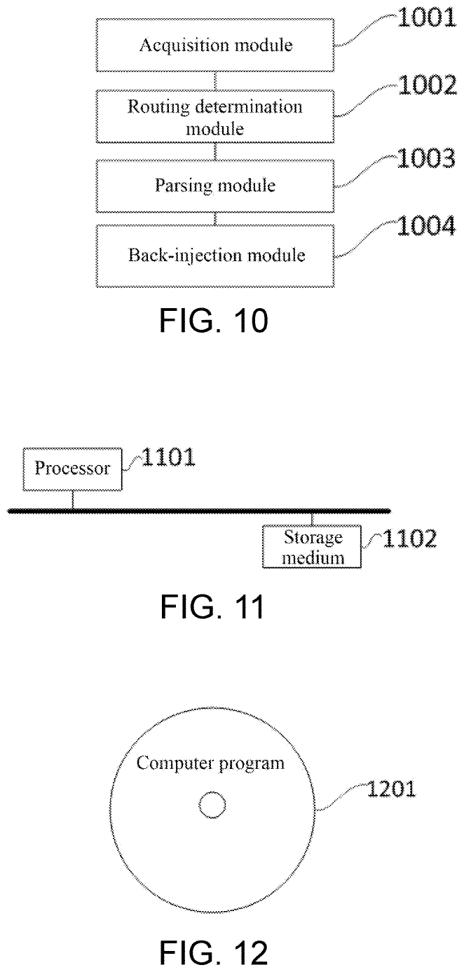

Referring to FIG. 10, there is shown a structural block diagram according to an embodiment of a vehicle data processing apparatus of the present application. The vehicle data processing apparatus is applied to a vehicle-mounted debugging industrial personal computer; the vehicle-mounted debugging industrial personal computer is connected to a vehicle-mounted intelligent driving host via a communication software gateway, a bridging channel and a mirroring channel, and the vehicle data processing apparatus may specifically include the following modules:
an acquisition module 1001, configured to perform data acquisition on basic software of a vehicle control operating system of the vehicle-mounted intelligent driving host via the communication software gateway, the bridging channel and the mirroring channel to generate a parsable file;
a routing determination module 1002, configured to determine a forwarding routing table according to the parsable file;
a parsing module 1003, configured to parse the parsable file to generate a network message; and
a back-injection module 1004, configured to back-inject the network message into the basic software of the vehicle control operating system based on the forwarding routing table.

In an embodiment of the present application, the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; the acquisition module 1001 includes:
a first acquisition submodule, configured to acquire and package data of the system-on-chip via the communication software gateway to generate a text format file;
a second acquisition submodule, configured to acquire and package data of the sensor via the bridging channel to generate a first packet capture format file;
a third acquisition submodule, configured to acquire and package data of the micro electronic control unit via the mirroring channel to generate a second packet capture format file; and
a combination submodule, configured to combine the text format file, the first packet capture format file and the second packet capture format file to generate the parsable file.

In an embodiment of the present application, the routing determination module 1002 includes:
a reading submodule, configured to read the parsable file, and determine a data processing process node corresponding to the parsable file; and
a routing determination submodule, configured to determine the forwarding routing table based on the data processing process node.

In an embodiment of the present application, the back-injection module 1004 includes:
a back-injection submodule, configured to back-inject the network message from the data processing process node to an operating node of the basic software of the vehicle control operating system.

In an embodiment of the present application, the data processing process node includes an output processing node, and the back-injection submodule includes:
a first back-injection unit, configured to back-inject the network message from the output processing node to the operating node of the basic software of the vehicle control operating system.

In an embodiment of the present application, the data processing process node further includes a process processing node, and the back-injection submodule further includes:
a second back-injection unit, configured to back-inject the network message sequentially into the process processing node, the output processing node, and the operating node of the basic software of the vehicle control operating system.

In an embodiment of the present application, the data processing process node further includes an input processing node, and the back-injection submodule further includes:
a third back-injection unit, configured to back-inject the network message sequentially into the input processing node, the process processing node, the output processing node, and the operating node of the basic software of the vehicle control operating system.

In an embodiment of the present application, a first debugging tool is pre-set in the system-on-chip; the apparatus further includes:
a first command sending module, configured to send a first debugging data capture command to the system-on-chip, where the system-on-chip is configured to activate the first debugging tool in response to the first debugging data capture command;
a first receiving module, configured to receive task scheduling monitoring data acquired by the first debugging tool; and
a first visualization module, configured to generating a flame graph file according to the task scheduling monitoring data.

In an embodiment of the present application, a second debugging tool is pre-set in the micro electronic control unit, and the apparatus further includes:
a second command sending module, configured to send a second debugging data capture command to the micro electronic control unit, where the micro electronic control unit is configured to activate the second debugging tool in response to the second debugging data capture command;
a second receiving module, configured to receive target operating duration data acquired by the second debugging tool;
a second visualization module, configured to combine the task scheduling monitoring data and the target operating duration data to generate joint scheduling curve data.

For the apparatus embodiments, since they are substantially similar to the method embodiments, the description thereof is relatively brief, and relevant contents may refer to the corresponding descriptions of the method embodiments.

Referring to FIG. 11, an embodiment of the present application further provides a vehicle, including:
a processor 1101 and a memory storing a storage medium 1102, and the storage medium 1102 stores computer programs executable by the processor 1101. When the vehicle is in operation, the processor 1101 executes the computer programs to implement the vehicle data processing method according to any embodiment of the present application.

The vehicle data processing method is applied to a vehicle-mounted debugging industrial personal computer; the vehicle-mounted debugging industrial personal computer is connected to a vehicle-mounted intelligent driving host via a communication software gateway, a bridging channel and a mirroring channel, the method includes:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

Further, the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; the step of performing data acquisition on the basic software of the vehicle control operating system of the vehicle-mounted intelligent driving host via the communication software gateway, the bridging channel and the mirroring channel to generate the parsable file includes:
acquiring and packaging data of the system-on-chip via the communication software gateway to generate a text format file;
acquiring and packaging data of the sensor via the bridging channel to generate a first packet capture format file;
acquiring and packaging data of the micro electronic control unit via the mirroring channel to generate a second packet capture format file; and
combining the text format file, the first packet capture format file and the second packet capture format file to generate the parsable file.

Further, the step of determining the forwarding routing table according to the parsable file includes:
reading the parsable file, and determining a data processing process node corresponding to the parsable file; and
determining the forwarding routing table based on the data processing process node.

Further, the step of back-injecting the network message into the basic software of the vehicle control operating system includes:
back-injecting the network message from the data processing process node to an operating node of the basic software of the vehicle control operating system.

Further, the data processing process node includes an output processing node, the step of back-injecting the network message from the data processing process node to the operating node of the basic software of the vehicle control operating system includes:
back-injecting the network message from the output processing node to the operating node of the basic software of the vehicle control operating system.

Further, the data processing process node further includes a process processing node, the step of back-injecting the network message from the data processing process node to the operating node of the basic software of the vehicle control operating system further includes:
back-injecting the network message sequentially into the process processing node, the output processing node, and the operating node of the basic software of the vehicle control operating system.

Further, the data processing process node further includes an input processing node, the step of back-injecting the network message from the data processing process node to the operating node of the basic software of the vehicle control operating system further includes:
back-injecting the network message sequentially into the input processing node, the process processing node, the output processing node, and the operating node of the basic software of the vehicle control operating system.

Further, a first debugging tool is pre-set in the system-on-chip; after the step of back-injecting the network message into the basic software of the vehicle control operating system based on the forwarding routing table, the method further includes:
sending a first debugging data capture command to the system-on-chip, where the system-on-chip is configured to activate the first debugging tool in response to the first debugging data capture command;
receiving task scheduling monitoring data acquired by the first debugging tool; and
generating a flame graph file according to the task scheduling monitoring data.

Further, a second debugging tool is pre-set in the micro electronic control unit, and the method further includes:
sending a second debugging data capture command to the micro electronic control unit, where the micro electronic control unit is configured to activate the second debugging tool in response to the second debugging data capture command;
receiving target operating duration data acquired by the second debugging tool; and
combining the task scheduling monitoring data and the target operating duration data to generate joint scheduling curve data.

The above-mentioned memory may include a random access memory (RAM), and may also include non-volatile memory, such as at least one disk storage. In an implementation, the memory may also be at least one storage device disposed remotely from the aforementioned processor.

The aforementioned processor may be a general-purpose processor, including a central processing unit (CPU), a network processor (NP), etc. It may also be a digital signal processor (DSP), an application specific integrated circuit (ASIC), a field-programmable gate array (FPGA), or other programmable logic devices, discrete gate or transistor logic devices, as well as discrete hardware components.

As shown in FIG. 12, an embodiment of the present application further provides a computer-readable storage medium 1201, where a computer program is stored on the computer-readable storage medium 1201, and the computer program, when executed by a processor, implements the vehicle data processing method according to any embodiment of the present application.

The vehicle data processing method is applied to a vehicle-mounted debugging industrial personal computer; the vehicle-mounted debugging industrial personal computer is connected to a vehicle-mounted intelligent driving host via a communication software gateway, a bridging channel and a mirroring channel, and the method includes:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

Further, the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; wherein the step of performing the data acquisition on the basic software of the vehicle control operating system of the vehicle-mounted intelligent driving host via the communication software gateway, the bridging channel and the mirroring channel to generate the parsable file includes:
acquiring and packaging data of the system-on-chip via the communication software gateway to generate a text format file;
acquiring and packaging data of the sensor via the bridging channel to generate a first packet capture format file;
acquiring and packaging data of the micro electronic control unit via the mirroring channel to generate a second packet capture format file; and
combining the text format file, the first packet capture format file and the second packet capture format file to generate the parsable file.

Further, the step of determining the forwarding routing table according to the parsable file includes:
reading the parsable file, and determining a data processing process node corresponding to the parsable file; and
determining the forwarding routing table based on the data processing process node.

Further, the step of back-injecting the network message into the basic software of the vehicle control operating system includes:
back-injecting the network message from the data processing process node to an operating node of the basic software of the vehicle control operating system.

Further, the data processing process node includes an output processing node, the step of back-injecting the network message from the data processing process node to the operating node of the basic software of the vehicle control operating system includes:
back-injecting the network message from the output processing node to the operating node of the basic software of the vehicle control operating system.

Further, the data processing process node further includes a process processing node, the step of back-injecting the network message from the data processing process node to the operating node of the basic software of the vehicle control operating system further includes:
back-injecting the network message sequentially into the process processing node, the output processing node, and the operating node of the basic software of the vehicle control operating system.

Further, the data processing process node further includes an input processing node, the step of back-injecting the network message from the data processing process node to the operating node of the basic software of the vehicle control operating system further includes:
back-injecting the network message sequentially into the input processing node, the process processing node, the output processing node, and the operating node of the basic software of the vehicle control operating system.

Further, a first debugging tool is pre-set in the system-on-chip; after the step of back-injecting the network packet into the basic software of the vehicle control operating system based on the forwarding routing table, the method further includes:
sending a first debugging data capture command to the system-on-chip, where the system-on-chip is configured to activate the first debugging tool in response to the first debugging data capture command;
receiving task scheduling monitoring data acquired by the first debugging tool; and
generating a flame graph file according to the task scheduling monitoring data.

Further, a second debugging tool is pre-set in the micro electronic control unit, and the method further includes:
sending a second debugging data capture command to the micro electronic control unit, where the micro electronic control unit is configured to activate the second debugging tool in response to the second debugging data capture command;
receiving target operating duration data acquired by the second debugging tool; and
combining the task scheduling monitoring data and the target operating duration data to generate joint scheduling curve data.

All embodiments in the specification are described in a progressive manner. Each embodiment focuses on the differences from other embodiments, and the same or similar parts among the embodiments may be mutually referenced.

Those skilled in the art shall understand that the embodiments of the present application may be implemented in the form of methods, apparatuses or computer program products. Accordingly, the embodiments of the present application may adopt the form of fully hardware embodiments, fully software embodiments, or embodiments combining software and hardware. Furthermore, the embodiments of the present application may take the form of computer program products implemented on one or more computer-usable storage media containing computer-usable program code, including but not limited to disk storage, CD-ROM and optical storage.

The embodiments of the present application are described with reference to the flowcharts and/or block diagrams of the methods, terminal devices (systems) and computer program products according to the embodiments of the present application. It should be understood that each process and/or block in the flowcharts and/or block diagrams, as well as combinations thereof, may be implemented by computer program instructions. These computer program instructions may be provided to processors of general-purpose computers, special-purpose computers, embedded processors or other programmable data processing terminal devices to create a machine, such that the instructions executed by the processors of a computer or other programmable data processing terminal device constitute means for implementing the functions specified in one or more processes of the flowcharts and/or one or more blocks of the block diagrams.

These computer program instructions may also be stored in the computer-readable memory capable of directing computers or other programmable data processing terminal devices to operate in a specific manner, so that the instructions stored in the computer-readable memory constitute articles of manufacture including instruction means which implement the functions specified in one or more processes of the flowcharts and/or one or more blocks of the block diagrams.

These computer program instructions may also be loaded into computers or other programmable data processing terminal devices to execute a series of operational steps thereon so as to generate computer-implemented processes, thereby the instructions executed on the computers or other programmable data processing terminal devices provide steps for implementing the functions specified in one or more processes of the flowcharts and/or one or more blocks of the block diagrams.

The above embodiments are merely embodiments for fully illustrating the present application, and the protection scope thereof is not limited thereto. Any equivalent substitutions or modifications made by the person skilled in the art on the basis of the present application shall fall within the protection scope of the present application.

What is claimed is:

1. A vehicle data processing method, wherein the method is applied to a vehicle-mounted debugging industrial personal computer; the vehicle-mounted debugging industrial personal computer is connected to a vehicle-mounted intelligent driving host via a communication software gateway, a bridging channel and a mirroring channel, the method comprises:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

2. The method according to claim 1, wherein the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; wherein the step of performing the data acquisition on the basic software of the vehicle control operating system of the vehicle-mounted intelligent driving host via the communication software gateway, the bridging channel and the mirroring channel to generate the parsable file comprises:
acquiring and packaging data of the system-on-chip via the communication software gateway to generate a text format file;
acquiring and packaging data of the sensor via the bridging channel to generate a first packet capture format file;
acquiring and packaging data of the micro electronic control unit via the mirroring channel to generate a second packet capture format file; and
combining the text format file, the first packet capture format file and the second packet capture format file to generate the parsable file.

3. The method according to claim 1, wherein the step of determining the forwarding routing table according to the parsable file comprises:
reading the parsable file, and determining a data processing process node corresponding to the parsable file; and
determining the forwarding routing table based on the data processing process node.

4. The method according to claim 3, wherein the step of back-injecting the network message into the basic software of the vehicle control operating system comprises:
back-injecting the network message from the data processing process node to an operating node of the basic software of the vehicle control operating system.

5. The method according to claim 4, wherein the data processing process node comprises an output processing node, and the step of back-injecting the network message from the data processing process node to the operating node of the basic software of the vehicle control operating system comprises:
back-injecting the network message from the output processing node to the operating node of the basic software of the vehicle control operating system.

6. The method according to claim 5, wherein the data processing process node further comprises a process processing node, and the step of back-injecting the network message from the data processing process node to the operating node of the basic software of the vehicle control operating system further comprises:
back-injecting the network message sequentially into the process processing node, the output processing node, and the operating node of the basic software of the vehicle control operating system.

7. The method according to claim 6, wherein the data processing process node further comprises an input processing node, and the step of back-injecting the network message from the data processing process node to the operating node of the basic software of the vehicle control operating system further comprises:
back-injecting the network message sequentially into the input processing node, the process processing node, the output processing node, and the operating node of the basic software of the vehicle control operating system.

8. The method according to claim 2, wherein a first debugging tool is pre-set in the system-on-chip; after the step of back-injecting the network message into the basic software of the vehicle control operating system based on the forwarding routing table, the method further comprises:
sending a first debugging data capture command to the system-on-chip, wherein the system-on-chip is configured to activate the first debugging tool in response to the first debugging data capture command;
receiving task scheduling monitoring data acquired by the first debugging tool; and
generating a flame graph file according to the task scheduling monitoring data.

9. The method according to claim 8, wherein a second debugging tool is pre-set in the micro electronic control unit, and the method further comprises:
sending a second debugging data capture command to the micro electronic control unit, wherein the micro electronic control unit is configured to activate the second debugging tool in response to the second debugging data capture command;
receiving target operating duration data acquired by the second debugging tool; and
combining the task scheduling monitoring data and the target operating duration data to generate joint scheduling curve data.

10. A vehicle data processing apparatus, wherein the apparatus is applied to a vehicle-mounted debugging industrial personal computer; the vehicle-mounted debugging industrial personal computer is connected to a vehicle-mounted intelligent driving host via a communication software gateway, a bridging channel and a mirroring channel, and the apparatus comprises: a processor, a memory, and a computer program stored in the memory and executable on the processor; wherein the computer program, when executed by the processor, implements the step of:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

11. The apparatus according to claim 10, wherein the vehicle-mounted debugging industrial personal computer is connected to a system-on-chip of the vehicle-mounted intelligent driving host via the communication software gateway, is connected to a sensor of the vehicle-mounted intelligent driving host via the bridging channel, and is connected to a micro electronic control unit of the vehicle-mounted intelligent driving host via the mirroring channel; the basic software of the vehicle control operating system is deployed on the system-on-chip, the sensor and the micro electronic control unit; the processor is specifically configured to:
acquire and packaging data of the system-on-chip via the communication software gateway to generate a text format file;
acquire and packaging data of the sensor via the bridging channel to generate a first packet capture format file;
acquire and packaging data of the micro electronic control unit via the mirroring channel to generate a second packet capture format file; and
combine the text format file, the first packet capture format file and the second packet capture format file to generate the parsable file.

12. The apparatus according to claim 10, wherein the processor is specifically configured to:
read the parsable file, and determining a data processing process node corresponding to the parsable file; and
determine the forwarding routing table based on the data processing process node.

13. The apparatus according to claim 12, wherein the processor is specifically configured to:
back-inject the network message from the data processing process node to an operating node of the basic software of the vehicle control operating system.

14. The apparatus according to claim 13, wherein the data processing process node comprises an output processing node, the processor is specifically configured to:
back-inject the network message from the output processing node to the operating node of the basic software of the vehicle control operating system.

15. The apparatus according to claim 14, wherein the data processing process node further comprises a process processing node, the processor is specifically configured to:
back-inject the network message sequentially into the process processing node, the output processing node, and the operating node of the basic software of the vehicle control operating system.

16. The apparatus according to claim 15, wherein the data processing process node further comprises an input processing node, the processor is specifically configured to:
back-inject the network message sequentially into the input processing node, the process processing node, the output processing node, and the operating node of the basic software of the vehicle control operating system.

17. The apparatus according to claim 11, wherein a first debugging tool is pre-set in the system-on-chip; after back-injecting the network message into the basic software of the vehicle control operating system based on the forwarding routing table, the processor is further configured to:
send a first debugging data capture command to the system-on-chip, wherein the system-on-chip is configured to activate the first debugging tool in response to the first debugging data capture command;
receive task scheduling monitoring data acquired by the first debugging tool; and
generate a flame graph file according to the task scheduling monitoring data.

18. The apparatus according to claim 17, wherein a second debugging tool is pre-set in the micro electronic control unit, the processor is further configured to:
send a second debugging data capture command to the micro electronic control unit, wherein the micro electronic control unit is configured to activate the second debugging tool in response to the second debugging data capture command;
receive target operating duration data acquired by the second debugging tool; and
combine the task scheduling monitoring data and the target operating duration data to generate joint scheduling curve data.

19. A vehicle, comprising: a processor, a memory, and a computer program stored in the memory and executable on the processor; wherein the computer program, when executed by the processor, implements the steps of:
performing data acquisition on basic software of a vehicle control operating system of the vehicle-mounted intelligent driving host via the communication software gateway, the bridging channel and the mirroring channel to generate a parsable file;
determining a forwarding routing table according to the parsable file;
parsing the parsable file to generate a network message; and
back-injecting the network message into the basic software of the vehicle control operating system based on the forwarding routing table.

20. A non-transitory computer-readable storage medium, wherein a computer program is stored on the non-transitory computer-readable storage medium, and the computer program, when executed by a processor, implements the steps of the vehicle data processing method according to claim 1.
